(19) United States
(12) Patent Application Publication
(10) Pub. No.: US 2003/0046106 A1
(43) Pub. Date: Mar. 6, 2003

(54) Sales system utilizing electronic communication system

(75) Inventor: Shinya Tsunoda, Kawasaki-shi (JP)

Correspondence Address: YOUNG & THOMPSON, 745 SOUTH 23RD STREET 2ND FLOOR, ARLINGTON, VA, 22202

(73) Assignee: NEC INFRONTIA CORPORATION, KAWASAKI-SHI (JP)

(21) Appl. No.: 10/229,166

(22) Filed: Aug. 28, 2002

(30) Foreign Application Priority Data
Aug. 31, 2001 (JP) 2001-263432

(51) Int. Cl. G06F 17/60

(52) U.S. Cl. 705/1

(57) ABSTRACT

A sales system is disclosed capable of effective afterward use of service data once obtained with a customer in a shop. Service members in the shop have their own portable data terminal units 3a to 3c for inputting data corresponding to contents of business talks with customers to form service data satisfying predetermined items. The service data is radio transmitted and stored in a shop computer 1. An initial business talk with a customer visiting the shop may not produce sales, but the service data obtained at that time are stored in a shop computer. The stored service data is made use of for transmitting purchase promotion data to the customer to thereby produce a change of a transaction with the customer.

### BACKGROUND OF THE INVENTION

This application claims benefit of Japanese Patent Application No. 2001-263432 filed on Aug. 31, 2001, the contents of which are incorporated by the reference.

The present invention relates to sales systems utilizing electronic communication system suited for use in department stores and specialist mass sales stores and, more particularly, to improvements in sales system capable of effective use of service data having been obtained before.

In the prior art, Japanese Patent Laid-Open No. 2000-207334 proposes a sales system, which seeks sales promotion by automatically classifying customers into different taste groups on the basis of the trend of access to internet by utilizing a particular device and providing, by electronic mails, data of products and services which are sought to be suited to each classified customer. With this method, compared to the case of providing data uniformly to all customers as in the prior art direct mail method, it is possible to greatly improve the so-called hit factor of actual product purchase and service utilization by customers.

As another prior art example, Japanese Patent Laid-Open No. 2000-315239 proposes a price collecting system, in which when a charged price amount is received at the time of a product transaction utilizing an electronic mail or the like, the charge is automatically deleted in a bank or like transfer dealing organ.

Furthermore, Japanese Patent Laid-Open No. 2001-43281 proposes a data processing system, in which an agent server accumulates customer data for providing these customer data to limited sales dealers registered as sales dealers meeting a predetermined standard, so that the customer side can receive highly reliable product information standard-meeting sales dealers.

Moreover, Japanese Patent Laid-Open No. 11-184926 discloses techniques concerning a POS system, which accumulates personal data to be utilized for automatic distribution, from a server, of direct mails of contents fitted to customer's consumption trends as electronic mails and thus enhancing the advertisement effect.

However, the proposals in the Japanese Patent Laid-Open 2000-207334, Japanese Patent Laid-Open 2001-43281 and Japanese Patent Laid-Open No. 11-184926 disclose great improvement in the so-called hit factor by effectively providing direct mails as electronic mails or the like to a large number of customers.

In the meantime, while Japanese Patent Laid-Open No. 2000-315239 proposes a charge collecting system for product transactions by electronic mails or the like. In this proposal, however, no method of making use of sales promotion data is provided.

By the way, in store sales in department stores and specialist mass sales stores, when no deal was closed despite a considerably long service, the service data obtained at this time was rarely utilized for sales. More specifically, frequently after customer's leaving without any deal closed due to such reasons as insufficient money held at that day, difficulty of purchase, that the price shown can not be directly agreed and a desire to consult with the family, the business talk data obtained with efforts are not subsequently utilized but are wasted. In car sales or the like, although it is usual that a business talk content including trade-in conditions is recorded on paper and that a copy of the record is given to the customer, even when the customer later determines the purchase based on the recorded content onthe paper, there is no case of car delivery made without any customer's talk in home or the sales shop with sales personnel after the initial business talk.

### SUMMARY OF THE INVENTION

An object of the present invention is to provide a sales system based on service data obtained from a customer visiting a shop afterwards as well and permitting purchase of a desired product without need for the customer to visit the shop again when determining the purchase afterwards.

According to an aspect of the present invention, there is provided a sales system utilizing shop service data to organize a tie-up relationship among a shop, an agent dealer, a bank and a delivery dealer such that data concerning predetermined items are mutually transmitted and received via electronic communication means for sales of a product dealt with by the shop by the agency of the agent dealer to the customer, wherein: the agent dealer functions to receive, from the shop, service data containing contents of business talk having been made in the shop, transmit, based on the service data, data for promoting customer's purchase for producing a business chance concerning a transaction with the customer, transmit, in response to a purchase order of a product concerning the service data from the customer, a transfer request data instructing the transfer of the price of the product and a predetermined fee to the bank to the customer, and after receiving, from the bank, a transfer notice that the transfer by the customer has been made, transmit, to the shop, an order issuance contact data indicative of the conclusion of sales concerning the service data and also indicative of the promotion of the product delivery; on the basis of the order issuance contact data the shop commands the delivery dealer to deliver the product to the customer; and when the agent dealer receives a delivery completion notice indicative of the completion of the delivery from the delivery dealer, it transmits, to the bank, a price payment command data instructing the payment of the price of the product transferred by the customer to the shop.

The agent dealer transmits the purchase promotion data by electronic mail to the customer. The agent dealer transmits data containing data of a different product relevant to the product concerning the service data as purchase promotion data to the customer. The agent dealer permits purchase order acceptance of a product concerning the service data from the customer with electronic communication means. The agent dealer transmits the transfer request data by electronic mail to the customer. In the shop each service member inputs data corresponding to contents of business talk with a customer to the own portable data terminal unit, whereby the service data is formed as data satisfying predetermined items and transmitted to be stored in a computer, the data stored in the computer being transmitted by the electronic communication means to the agent dealer. The portable data terminal unit is of such specifications that the data can be radio transmitted from the site of the business talk to the computer.

According to another aspect of the present invention, there is provided a sales system utilizing shop service data, wherein each service member in the shop has an own portable type data terminal unit, inputs data corresponding to contents of business talk made with a customer in the shop to the portable data terminal unit, service data containing the contents of the business talk with the customer is performed as data satisfying predetermined items and is transmitted for storage in a computer, service activity to the customer is made with electronic communication system based on the data stored in the computer at an instant after the business talk to produce a business chance concerning the customer, and a purchase order of a product concerning the service data from the customer is accepted with the electronic communication means.

The service data includes as the predetermined items the name, address, telephone number and electronic mail address of the customer, data specifying a product concerning the business talk and desired purchase conditions concerning the product. The electronic mail is utilized as the electronic communication means. At an instant after the business talk has once been made, sales concerning the business talk can be made without need of waiting for the visit of the customer to the shop by utilizing the electronic communication means.

Other objects and features will be clarified from the following description with reference to attached drawings.

### BRIEF DESCRIPTION OF THE DRAWINGS

FIG. 1 shows a schematic view for explaining an exemplified sales system construction according to the present invention is applied; and

FIG. 2 is a view for describing one embodiment of the same method according to the present invention, which is carried out in the system shown in FIG. 1.

### PREFERRED EMBODIMENTS OF THE INVENTION

Preferred embodiments of the present invention will now be described with reference to the drawings.

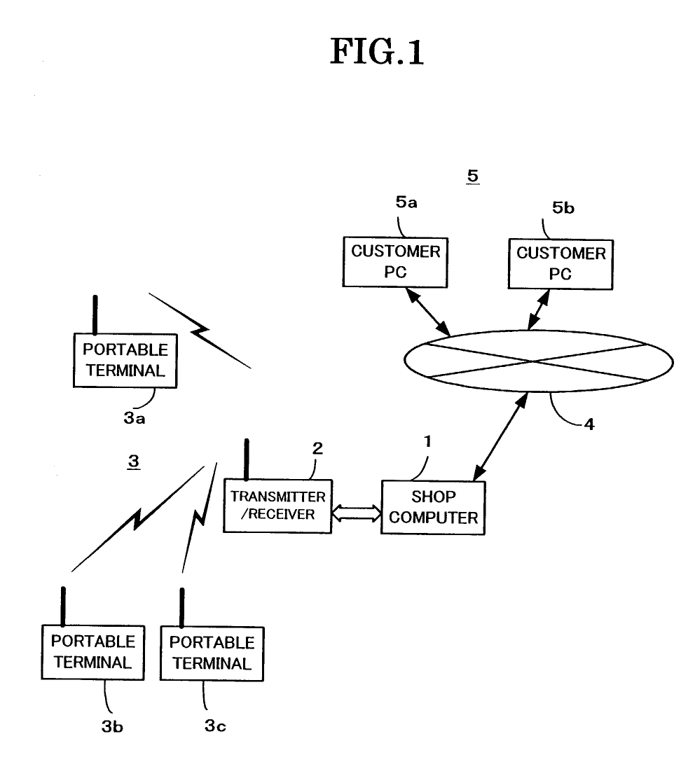

FIG. 1 is a schematic view for explaining an exemplified sales system according to the present invention is applied.

Referring to FIG. 1, to a shop computer, which is installed in a shop, such as a department store and a specialist mass sales store, is connected to transmitter/receiver 2 for radio transmitting and receiving data. In the shop, individual service members having their own portable data terminal units 3 (3a to 3c) input data corresponding to contents of business talks with customers in the shop the units 3a to 3c. By these data input operations, service data containing contents of business talks with customers are formed as data satisfying predetermined items. The data thus formed are radio transmitted from the portable data terminal units 3a to 3c to the transmitter/receiver 2 and stored in the shop computer 1.

While in the shop initial business talks with customers visiting the shop may not produce sales, the service data that are obtained are stored as data satisfying predetermined items in the shop computer 1. The predetermined items may include the name, address, telephone number and electronic mail address of the customer, data specifying the product concerning the business talk and desired product purchase conditions.

On the shop side, according to these data the shop side thus produces business chances about transactions with customers having visited the shop by transmitting data for promoting the customer's purchase by itself or by the agency of agent dealers via network (i.e., electronic mails) 4 to the customers. When purchase orders of products concerning the above service data are received from customers having received the purchase promotion data in customer side personal computers 5 (5a and 5b) via the network 4, product delivery and price collection are done in the manner as will be described later.

As shown above, after a business talks has once been made in the shop, sales can be made without need for the customer to visit the shop again but by utilizing electronic communication means.

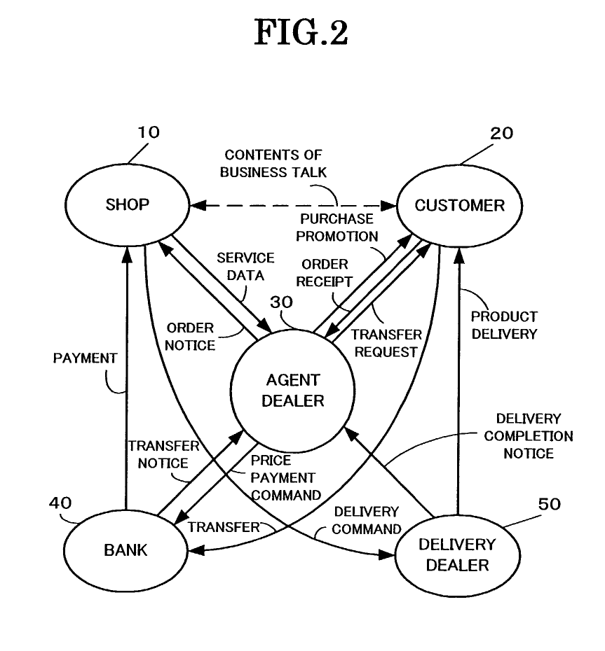

FIG. 2 is a view for describing one embodiment of the same method according to the present invention, which is carried out in the system shown in FIG. 1.

In this sales system, a tie-up relationship among a shop 10, a customer 20, an agent dealer 30 a bank 40 and a delivery dealer 50 is set up for mutual transmission and reception of data concerning predetermined items via a network (i.e., electronic mails) or like electronic communication means. In this way, products dealt with by the shop 10 are sold by the agency of the agent dealer 30 to the customer 20.

As described before in connection with FIG. 1, in the shop the individual service members have their own portable data terminal units 3 (3a to 3c), and by inputting data to these portable data terminal units service data containing the contents of business talks with customers are formed as data satisfying predetermined items and are radio transmitted to be stored in the shop computer 1. The agent dealer 30 receives the service data, which are stored in the shop computer 1 in the shop 10, from the shop 10 via suitable data communication means, and according to these service data it produces business chances about transactions with the customers by transmitting purchase promotion data to the customers 10. As described before in connection with FIG. 1, the purchase promotion to the customers 10 is made via the network (i.e., electronic mails) 4. The agent dealer 4 may also transmit data containing data of other products relevant to the products pertaining to the above service data as data for promoting purchases by the customers 10 to the customers 10.

When the agent dealer 30 receives an order of purchase of a product pertaining to the service data (or a different product relevant to the product pertaining to the service data) from the customer 10, it transmit a transfer request data requesting the transfer of the price of the product and a predetermined service fee to the bank 40 to the customer 10. The transmission of the transfer request data may be performed by an electronic mail. After the agent dealer 30 has received from the bank 40 a transfer notice indicative of the commitment of the transfer to the bank 10, it transmits order issuance contact data indicative of the conclusion of transaction pertinent to the service data and also indicative of the promotion of the product delivery to the shop 10.

According to the above order issuance contact data from the agent dealer 30, the shop 10 transmits to the delivery dealer 40 a delivery command for delivering the product to the customer 10. When the delivery dealer 40 has completed the delivery concerning the delivery command, it transmits to the agent dealer 30 a delivery completion notice indicative of the completion of the delivery concerning the delivery command. When the agent dealer 40 receives the delivery completion notice, it transmits to the bank 40 a price payment command data instructing the payment of the price of the product to the shop 10 from the above amount transferred by the customer 20. When the bank 40 transfers the price amount to the account of the shop 10 as in the price payment command data, the price collection by the shop 10 is completed. In this case, the agent dealer 30 receives an agent fee in an appropriate method from the shop 10 or the like.

As has been described in the foregoing, with the sales system described before in connection with FIGS. 1 and 2, even in the case when initial service to a customer visited in the shop 10 could have not directly produced any sales result, the service data once obtained at that time can be made effective use of for sales activity to the customer so as to obtain the possibility of sales.

Also, as will be understood from the above description in connection with FIGS. 1 and 2, the side of the customer 20 can order the purchase of a product using the personal computer 5 via the network 4 (i.e., electronic mail) to the agent dealer 30. Thus, after a business talk has once been made in the shop 10, the customer 20 can purchase a desired product without need of visiting the shop 10 again but by utilizing electronic communication means.

Thus, according to the present invention it is possible to provide a sales system, which permits effective afterward use of service data once obtained in service in the shop and also permits the customer to purchase a desired product without need of visiting the shop again when determining the purchase afterwards.

Changes in construction will occur to those skilled in the art and various apparently different modifications and embodiments may be made without departing from the scope of the present invention. The matter set forth in the foregoing description and accompanying drawings is offered by way of illustration only. It is therefore intended that the foregoing description be regarded as illustrative rather than limiting.

What is claimed is:

1. A sales system utilizing shop service data to organize a tie-up relationship among a shop, an agent dealer, a bank and a delivery dealer such that data concerning predetermined items are mutually transmitted and received via electronic communication means for sales of a product dealt with by the shop by the agency of the agent dealer to the customer, wherein:
the agent dealer functions to receive, from the shop, service data containing contents of business talk having been made in the shop, transmit, based on the service data, data for promoting customer's purchase for producing a business chance concerning a transaction with the customer, transmit, in response to a purchase order of a product concerning the service data from the customer, a transfer request data instructing the transfer of the price of the product and a predetermined fee to the bank to the customer, and after receiving, from the bank, a transfer notice that the transfer by the customer has been made, transmit, to the shop, an order issuance contact data indicative of the conclusion of sales concerning the service data and also indicative of the promotion of the product delivery;
on the basis of the order issuance contact data the shop commands the delivery dealer to deliver the product to the customer; and
when the agent dealer receives a delivery completion notice indicative of the completion of the delivery from the delivery dealer, it transmits, to the bank, a price payment command data instructing the payment of the price of the product transferred by the customer to the shop.

2. The sales system utilizing shop service data according to claim 1, wherein the agent dealer transmits the purchase promotion data by electronic mail to the customer.

3. The sales system utilizing shop service data according to claim 1, wherein the agent dealer transmits data containing data of a different product relevant to the product concerning the service data as purchase promotion data to the customer.

4. The sales system utilizing shop service data according to claim 1, wherein the agent dealer permits purchase order acceptance of a product concerning the service data from the customer with electronic communication means.

5. The sales system utilizing shop service data according to claim 1, wherein the agent dealer transmits the transfer request data by electronic mail to the customer.

6. The sales system utilizing shop service data according to claim 1, wherein in the shop each service member inputs data corresponding to contents of business talk with a customer to the own portable data terminal unit, whereby the service data is formed as data satisfying predetermined items and transmitted to be stored in a computer, the data stored in the computer being transmitted by the electronic communication means to the agent dealer.

7. The sales system utilizing shop service data according to claim 6, wherein the portable data terminal unit is of such specifications that the data can be radio transmitted from the site of the business talk to the computer.

8. A sales system utilizing shop service data, wherein each service member in the shop has an own portable type data terminal unit, inputs data corresponding to contents of business talk made with a customer in the shop to the portable data terminal unit, service data containing the contents of the business talk with the customer is performed as data satisfying predetermined items and is transmitted for storage in a computer, service activity to the customer is made with electronic communication system based on the data stored in the computer at an instant after the business talk to produce a business chance concerning the customer, and a purchase order of a product concerning the service data from the customer is accepted with the electronic communication means.

9. The sales system utilizing shop service data according to claim 8, wherein the service data includes as the predetermined items the name, address, telephone number and electronic mail address of the customer, data specifying a product concerning the business talk and desired purchase conditions concerning the product.

10. The same method utilizing shop service data according to claim 8, wherein electronic mail is utilized as the electronic communication means.

11. The sales system utilizing shop service data according to claim 8, wherein at an instant after the business talk has once been made, sales concerning the business talk can be made without need of waiting for the visit of the customer to the shop by utilizing the electronic communication means.
